(19) United States
(12) Patent Application Publication
(10) Pub. No.: US 2026/0056592 A1
(43) Pub. Date: Feb. 26, 2026

(54) Adaptive Power Management for Video-Recording Doorbell Systems

(71) Applicant: Google LLC, Mountain View, CA (US)

(72) Inventors: Yu-Ting Yeh, Taipei (TW); ChiHuan Chen, New Taipei City (TW); Fu-Ming Hsu, Hsinchu (TW); Dayu Qu, Cupertino, CA (US)

(73) Assignee: Google LLC, Mountain View, CA (US)

(21) Appl. No.: 18/812,688

(22) Filed: Aug. 22, 2024

(51) Int. Cl. G06F 1/3212; G08B 3/10; H04N 7/18

(52) U.S. Cl. CPC G06F 1/3212; G08B 3/10; H04N 7/186

(57) ABSTRACT

The present document describes techniques associated with adaptive power management for Internet-of-Things (IoT) doorbell systems. These techniques integrate supercapacitors as a secondary power source for an IoT doorbell system. Supercapacitors provide significant advantages, including longer cycle life, reduced carbon footprint throughout their lifecycle, and superior performance under harsh environmental conditions. These techniques also incorporate an adaptive input power management system, which enhances the system's compatibility by enabling the IoT doorbell to function with a lower-powered transformer, such as those found in older households. Further, an adaptive chime management system is incorporated, which improves reliability of operation of a supercapacitor-powered doorbell system.

### BACKGROUND

Many existing Internet-of-Things (IoT) doorbell systems primarily rely on batteries, such as Lithium-ion batteries (LIB), for power. These batteries, however, face several challenges, including environmental impact, limited lifespan, and safety concerns. For example, LIB production and disposal contribute to carbon emissions, posing concerns for environmentally conscious consumers and requiring alignment with regulation on carbon reduction. Harsh outdoor environments accelerate LIB degradation, leading to shorter-than-expected lifespans and the need for frequent replacement of the batteries, which creates inconvenience for consumers and increases electronic waste. In some cases, LIBs can pose safety risks due to potential thermal runaway events.

### SUMMARY

The present document describes techniques associated with adaptive power management for video-recording doorbell systems. These techniques integrate supercapacitors as a secondary power source for an IoT doorbell system. Supercapacitors provide significant advantages, including longer cycle life, reduced carbon footprint throughout their lifecycle, and superior performance under harsh environmental conditions. These techniques also incorporate an adaptive input power management system, which enhances the system's compatibility by enabling the IoT doorbell to function with a lower-powered transformer, such as those found in older households. Further, an adaptive chime management system is incorporated, which improves reliability of operation of a supercapacitor-powered doorbell system.

In one example, a video-recording doorbell is disclosed. The video-recording doorbell includes a housing, one or more supercapacitors, a charger, an adaptive input manager module, and a microcontroller unit (MCU). The one or more supercapacitors are disposed within the housing and are configured to provide secondary input power for operation of the video-recording doorbell when primary input power is temporarily switched to provide power to a doorbell chime electrically connected to the video-recording doorbell. The charger is configured to charge the one or more supercapacitors. The adaptive input manager module is configured to detect a presence of the primary input power and determine an input voltage of the primary input power. The MCU is configured to set an initial charge current for charging the one or more supercapacitors, enable the charger to charge the one or more supercapacitors using the initial charge current, and adjust the initial charge current to a new charge current based on the input voltage and a voltage threshold.

In another example, a video-recording doorbell system is disclosed. The video-recording doorbell system includes a video-recording doorbell, a doorbell chime, a transformer, a chime connector, an adaptive input manager module, and a microcontroller. The video-recording doorbell includes one or more supercapacitors configured to provide secondary input power to the video-recording doorbell. The doorbell chime is electrically connected to the video-recording doorbell and configured to generate an audio signal in response to activation of a button on the video-recording doorbell. The transformer is connected to the doorbell chime and the video-recording doorbell, the transformer configured to provide primary input power to the video-recording doorbell. The chime connector is connected to the doorbell chime and the video-recording doorbell. The chime connector is configured to switch the primary input power between the video-recording doorbell and the doorbell chime based on activation of the button. The adaptive input manager module is implemented in the video-recording doorbell and configured to determine a voltage of the primary input power and determine a power quality of the primary input power based on the voltage. The microcontroller is disposed within the video-recording doorbell and configured to set an initial charge current for charging the one or more supercapacitors, enable charging of the one or more supercapacitors using the initial charge current, and adjust the initial charge current to a new charge current based on the power quality and a threshold value.

In another example, a method is disclosed. The method includes: retrieving information regarding a charge current being used to charge one or more supercapacitors of a video-recording doorbell; determining a recharge time, based on the information regarding the charge current, to fully charge the one or more supercapacitors of the video-recording doorbell, the one or more supercapacitors configured to provide secondary power to the video-recording doorbell during activation of a doorbell chime electrically connected to the video-recording doorbell; determining a chime duration for the doorbell chime based on a capability and discharge time of the one or more supercapacitors; and causing an activation time of the doorbell chime to be set equal to or less than the determined chime duration.

This summary is provided to introduce simplified concepts of adaptive power management for video-recording doorbell systems, which are further described below in the Detailed Description.

### BRIEF DESCRIPTION OF THE DRAWINGS

The details of one or more aspects of adaptive power management for video-recording doorbell systems are described in this document with reference to the following drawings. The same numbers are used throughout the drawings to reference like features and components:

FIG. 1 illustrates an example environment in which aspects of adaptive power management for video-recording doorbell systems can be implemented;

FIG. 2 illustrates an example network environment in which aspects of adaptive power management for video-recording doorbell systems can be implemented;

FIG. 3 illustrates an example implementation of an electronic device, such as the video-recording doorbell from FIG. 1, in more detail;

FIG. 4 illustrates an isometric view of an example video-recording doorbell having a camera module, in accordance with some implementations;

FIGS. 5-7 illustrates example implementations of video-recording doorbell systems in accordance with the techniques described herein;

FIG. 8 illustrates an example implementation of a user interface for a mobile device configured to communicate with a video-recording doorbell system over a network;

FIG. 9 depicts an example method for adaptive power management for video-recording doorbell systems, in accordance with one or more implementations described herein;

FIG. 10 depicts an example method for adaptive chime management, in accordance with one or more implementations described herein;

FIG. 11 illustrates an example environment in which a home area network, as described with reference to FIG. 1, and aspects of adaptive power management for video-recording doorbell systems can be implemented;

FIG. 12 illustrates an example wireless network device that can be implemented as any of the wireless network devices in a home area network in accordance with one or more aspects of adaptive power management for video-recording doorbell systems as described herein; and

FIG. 13 illustrates an example system that includes an example device, which can be implemented as any of the wireless network devices that implement aspects of adaptive power management for video-recording doorbell systems as described with reference to the previous FIGS. 1-12.

### DETAILED DESCRIPTION

The present document describes adaptive power management for video-recording doorbell systems. Generally, IoT doorbells systems rely on a transformer for primary power input and the power generated by the transformer is switched (e.g., diverted) to a mechanical or electronic chime when the doorbell button is pressed. During the ringing of the chime, the doorbell relies on secondary power, generally provided by a battery. However, the video-recording doorbell systems described herein use one or more supercapacitors to provide the secondary power to the doorbell. Supercapacitors are high-capacity capacitors, with a capacitance value much higher than solid-state capacitors but with lower voltage limits. Unlike ordinary capacitors, supercapacitors do not use a conventional solid dielectric, but rather, supercapacitors use electrostatic double-layer capacitance and electrochemical pseudo-capacitance, both of which contribute to the total capacitance of the capacitor. Supercapacitors provide various benefits over batteries, including longer cycle life, reduced carbon footprint throughout their lifecycle, and superior performance under harsh environmental conditions.

Supercapacitors can also be charged significantly faster than batteries, without experiencing degradation. Consequently, supercapacitors can enable the chime to ring more often, if needed. In aspects, the techniques described herein provide the ability for the system to adapt to existing transformers and wiring, including some found in older households that may experience voltage dips during rapid charging. For example, the techniques described herein can adapt the amount of charge current used to charge the supercapacitors based on the power quality of the primary input power to prevent exceeding the transformer's capacity.

However, supercapacitors also discharge significantly faster than batteries. Adaptive power management for video-recording doorbell systems is employed to prevent system shutdown that may occur if the supercapacitors discharge completely before the ringing of the chime ends. For example, the techniques described herein can automatically adjust the maximum duration of time for the chime to ring, which can prevent complete depletion of the supercapacitors. Although the supercapacitors can be fully charged quickly, such as within seconds or tens of seconds, there may be some circumstances in which the doorbell button is pressed frequently in a short period of time. In one example, on Halloween, hundreds of children may ring the doorbell to “trick-or-treat” within a matter of a couple of hours. In another example, a single person might ring the doorbell button repeatedly within a matter of seconds, in an urgent attempt to get the homeowner to answer the door (e.g., due to an emergency). Without the power management techniques described herein, the supercapacitors could experience full discharge and cause a system shutdown. In these examples, the adaptive power management system can automatically reduce the chime duration for subsequent presses of the doorbell button, such as from a 10-second ring to an 8-second ring and subsequently to a 5-second ring, and so on.

Accordingly, to manage the power of the IoT doorbell system, including charge current and discharge times, the system includes an adaptive input power management system and an adaptive chime management system configured to enable the above-described functionality and features. In particular, the adaptive input power management system automatically manages power and chime duration of an IoT doorbell system having supercapacitors as a secondary power source.

While features and concepts of the described techniques for adaptive power management for video-recording doorbell systems can be implemented in any number of different environments, aspects are described in the context of the following examples.

### Example Environment

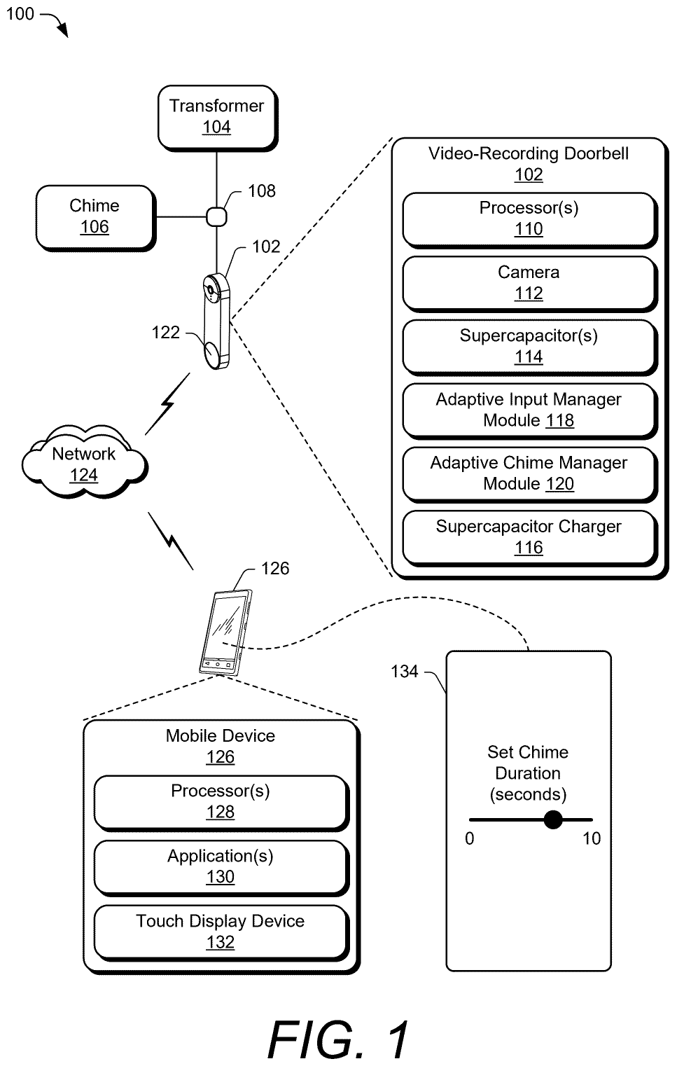

FIG. 1 illustrates an example system environment 100 in which aspects of adaptive power management for video-recording doorbell systems can be implemented. The example system environment 100 includes an electronic doorbell device (e.g., a video-recording doorbell 102) electrically connected to a transformer 104 and a doorbell chime (e.g., chime 106) via a chime connector 108. The video-recording doorbell 102 can include components and circuitry that enable various aspects of adaptive power management, including one or more processors 110 (e.g., microprocessor unit (MCU)), a camera 112, one or more supercapacitors 114, a supercapacitor charger 116, an adaptive input manager module 118 (AIM module 118), and, in some cases, an adaptive chime manager module 120 (ACM module 120).

The transformer 104 is connected to both the video-recording doorbell 102 and the chime 106 via the chime connector 108. As is described in further detail herein, the transformer 104 provides electrical power usable by the video-recording doorbell 102. However, when a button 122 of the doorbell 102 is activated (e.g., pushed by a user), the electrical power provided by the transformer 104 is switched, by the chime connector 108, to activate the chime 106 to enable the chime 106 to output an audio signal (e.g., doorbell ring). During a time period (e.g., 3 seconds(s), 5 s, 8 s) in which the electrical power is switched to activate the chime 106, the electrical power is unavailable to the video-recording doorbell 102. Accordingly, in order to continue operation, the video-recording doorbell 102 uses a secondary power source. In this case, the video-recording doorbell 102 draws secondary power from the supercapacitors 114.

The chime connector 108, for example, detects a change in AC voltage when the button 122 of the doorbell 102 is activated. Based on the detected change in the AC voltage, such as a voltage level exceeding a voltage level threshold (e.g., 0.4 Volts (V), 0.5 V), a controller of the chime connector 108 activates a bypass switch (e.g., a relay, a solid-state relay, a mechanical switch, a magnetic switch). The bypass switch can be configured as a normally closed (NC) switch or a normally open (NO) switch. Responsive to the activation of the bypass switch, the controller of the chime connector 108 sets a lockout timer defining the time period for the chime 106 to be activated (e.g., duration for the doorbell to ring). Responsive to expiration of the lockout timer, the controller of the chime connector 108 deactivates the bypass switch (e.g., if the bypass switch is NC, the controller closes the bypass switch, if the bypass switch an NO, the controller opens the bypass switch).

The AIM module 118 manages and controls recharging of the supercapacitors 114. For example, the AIM module 118 can monitor a power quality of primary input power provided by the transformer 104 and determine a charge current (e.g., optimal charge current) usable to charge the supercapacitors 114. Because of supercapacitor kinetics, the supercapacitors 114 can be recharged quickly (e.g., within seconds) depending on the amount of charge current applied.

The ACM module 120 can manage and control the duration of the chime activation (e.g., duration of the doorbell ring). For example, to prevent shutdown of the video-recording doorbell 102 due to the supercapacitors 114 being fully depleted, the ACM module 120 can automatically reduce the duration of the doorbell ring (e.g., chime duration) such that the primary input power is switched back to the video-recording doorbell 102 before the supercapacitors 114 are fully depleted. For example, the video-recording doorbell 102 can include a switch controlled by the MCU 510. The ACM module 120 can provide input to the MCU 510 to control the switch, which changes the voltage and/or current flowing through the chime connector 108. Such a change to the voltage and/or current effectively controls the bypass switch in the chime connector 108, thereby controlling the duration of the chime activation. In one example, the ACM module 120 sets or adjusts (e.g., decrease, increase) a timer for the switch in the video-recording doorbell 102 that causes the switch to change states (e.g., activate, deactivate) for a duration of time, which defines the chime duration of the doorbell chime 106. When the timer expires, the switch changes back to its original state, causing the voltage and/or current flowing through the chime connector 108 to change and the bypass switch to activate or deactivate, resulting in the primary power being switched back to the video-recording doorbell 102. Further, when the primary input power is switched back to the video-recording doorbell 102, the video-recording doorbell 102 can begin recharging the supercapacitors 114.

The video-recording doorbell 102 can communicate with one or more devices over a network 124. The video-recording doorbell 102 can be wirelessly connected to the network 124 or wired to the network 124. In an example, the video-recording doorbell 102 communicates with a mobile device 126 (e.g., smartphone, tablet, laptop, smartwatch) over the network 124. The mobile device 126 can include one or more processors 128 that can execute one or more applications 130 with content displayable via a touch display device 132. In one example, the mobile device 126 can provide a user interface 134 via the touch display device 132. The user interface 134 can provide access to user-selectable settings including an adjustable chime duration of the chime 106, giving the user some control over a length of time that the chime 106 rings.

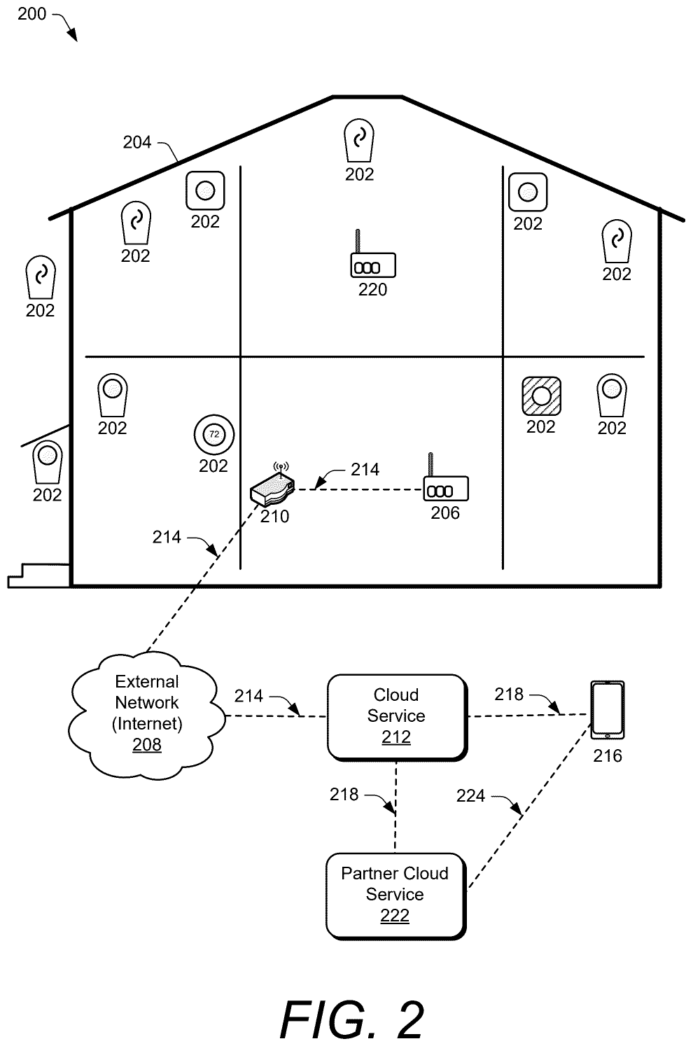

FIG. 2 illustrates an example network environment 200 in which aspects of adaptive power management for video-recording doorbell systems can be implemented. As described herein, the network environment 200 includes various IoT devices, which connect and exchange data with other devices over a network such as the Internet. In aspects, the network environment 200 includes a home area network (HAN). The HAN includes wireless network devices 202 (e.g., electronic devices) that are disposed about a structure 204, such as a house, and are connected by one or more wireless and/or wired network technologies, as described below. An example of a wireless network device 202 includes the video-recording doorbell 102. The HAN includes a border router 206 that connects the HAN to an external network 208, such as the Internet, through a home router or access point 210.

To provide user access to functions implemented using the wireless network devices 202 in the HAN, a cloud service 212 connects to the HAN via the border router 206, via a secure tunnel 214 through the external network 208 and the access point 210. One example of the cloud service 212 includes the network 124 in FIG. 1. The cloud service 212 facilitates communication between the HAN and Internet clients 216, such as apps on mobile devices (e.g., the mobile device 126), using a web-based application programming interface (API) 218. The cloud service 212 also manages a home graph that describes connections and relationships between the wireless network devices 202, elements of the structure 204, and users. The cloud service 212 hosts controllers that orchestrate and arbitrate home automation experiences, as described in greater detail below.

The HAN may include one or more wireless network devices 202 that function as a hub 220. The hub 220 may be a general-purpose home automation hub, or an application-specific hub, such as a security hub, an energy management hub, a heating, ventilation, and air conditioning (HVAC) hub, and so forth. The functionality of a hub 220 may also be integrated into any wireless network device 202, such as a smart thermostat device or the border router 206. In addition to hosting controllers on the cloud service 212, controllers can be hosted on any hub 220 in the structure 204, such as the border router 206. A controller hosted on the cloud service 212 can be moved dynamically to the hub 220 in the structure 204, such as moving an HVAC zone controller to a newly installed smart thermostat.

Hosting functionality on the hub 220 in the structure 204 can improve reliability when the user's internet connection is unreliable, can reduce latency of operations that would normally have to connect to the cloud service 212, and can satisfy system and regulatory constraints around local access between wireless network devices 202.

The wireless network devices 202 in the HAN may be from a single manufacturer that provides the cloud service 212 as well, or the HAN may include wireless network devices 202 from partners. These partners may also provide partner cloud services 222 that provide services related to their wireless network devices 202 through a partner web API 224. The partner cloud service 222 may optionally or additionally provide services to Internet clients 216 via the web-based API 218, the cloud service 212, and the secure tunnel 214.

The network environment 200 can be implemented on a variety of hosts, such as battery-powered microcontroller-based devices, supercapacitor-powered microcontroller-based devices, line-powered devices, and servers that host cloud services. Protocols operating in the wireless network devices 202 and the cloud service 212 provide a number of services that support operations of home automation experiences in the distributed computing environment 200. These services include, but are not limited to, real-time distributed data management and subscriptions, command-and-response control, real-time event notification, historical data logging and preservation, cryptographically controlled security groups, time synchronization, network and service pairing, and software updates.

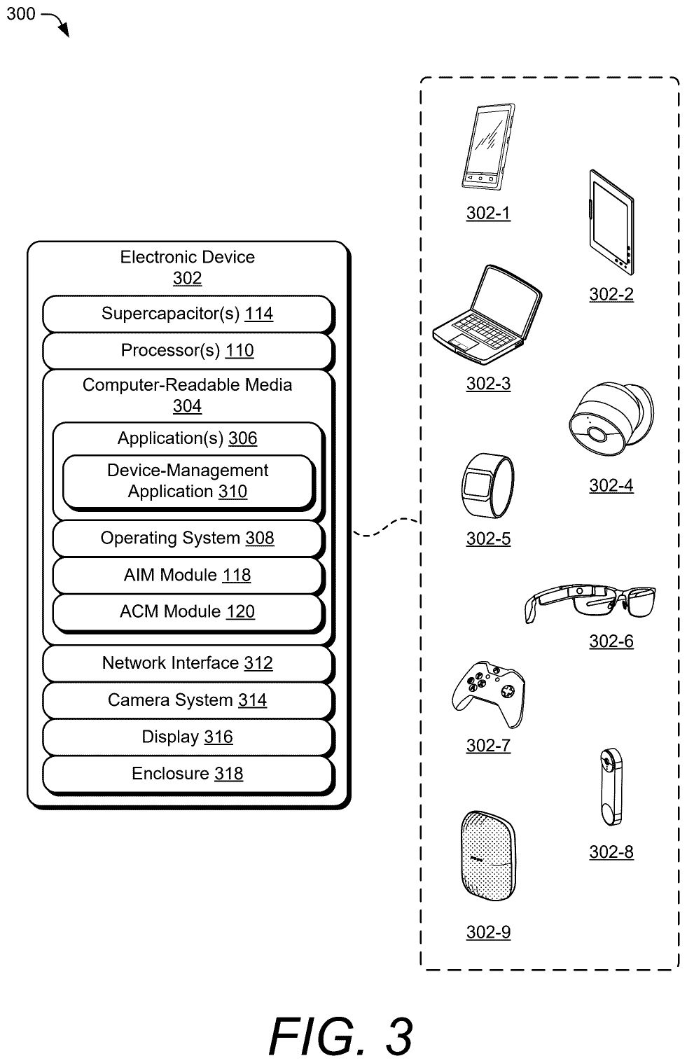

FIG. 3 illustrates an example implementation of an electronic device, such as the video-recording doorbell 102 from FIG. 1, in more detail. The electronic device 302 (e.g., the wireless network device 202, mobile device) of FIG. 2 is illustrated with a variety of example devices, including a smartphone 302-1, a tablet 302-2, a laptop 302-3, a security camera 302-4, a computing watch 302-5, computing spectacles 302-6, a gaming system 302-7, a video-recording doorbell 302-8, and a speaker 302-9. The electronic device 302 can also include other devices (e.g., televisions, entertainment systems, desktop computers, audio systems, projectors, automobiles, drones, track pads, drawing pads, netbooks, e-readers, home security systems, camera systems, thermostats, and other home appliances). Note that the electronic device 302 can be mobile, wearable, non-wearable but mobile, or relatively immobile (e.g., desktops and appliances).

The electronic device 302 includes a rechargeable power source, such as the supercapacitor(s) 114. The supercapacitor 114, also known as an ultracapacitor, is an electric energy storage device in which an electric double layer between a polarizable electrode surface and an electrolyte stores electric charge. Example values of energy and power densities of commercially available supercapacitors are in a range of 4 to 5 Watt-hours per kilogram (Wh/kg) and 10 to 20 kilowatts per kilogram (kW/kg). Unlike ordinary capacitors, supercapacitors do not use a conventional solid dielectric. Rather, supercapacitors use electrostatic double-layer capacitance and electrochemical pseudocapacitance, both of which contribute to the total capacitance of the supercapacitor. Compared to battery materials, supercapacitors include a wider temperature range, environmental friendliness, better safety, higher reliability, and maintenance-free operation. Further, supercapacitors can accept and deliver charge significantly faster than batteries and can tolerate many more charge and discharge cycles than rechargeable batteries, such as thousands, tens of thousands, hundreds of thousands, or millions of cycles before experiencing degradation.

The electronic device 302 includes one or more processors 110 (e.g., any of microprocessors, controllers, or other controllers) that can process various computer-executable instructions to control the operation of the electronic device 302 and to enable techniques for adaptive power management for video-recording doorbell systems. The processors 110 are described in further detail below.

The electronic device 302 also includes computer-readable media 304 (CRM 304) that provide storage for various applications 306 and system data. Applications 306 and/or an operating system 308 implemented as computer-readable instructions on the computer-readable media 304 (e.g., the storage media) can be executed by the processor(s) 110 to provide some or all of the functionalities described herein. The computer-readable media 304 provide data storage mechanisms to store various device applications 306, an operating system 308, memory/storage, and other types of information and/or data related to operational aspects of the electronic device 302. For example, the operating system 308 can be maintained as a computer application within the computer-readable media 304 and executed by the processor(s) 110 to provide some or all of the functionalities described herein. The device applications 306 may include a device-management application 310, such as any form of a control application, a software application, or signal-processing and control modules. The device applications 306 may also include system components, engines, or managers to implement techniques for adaptive power management for video-recording doorbell systems, such as the AIM module 118, the ACM module 120, and so on. The electronic device 302 may also include, or have access to, one or more machine learning systems.

Various implementations of the AIM module 118 and the ACM module 120 can include, or communicate with, a system-on-chip (SoC), one or more integrated circuits (ICs), a processor with embedded processor instructions or configured to access processor instructions stored in memory, hardware with embedded firmware, a printed circuit board with various hardware components, or any combination thereof.

The AIM module 118 is configured to monitor the input voltage of the primary input power and determine the power quality of the primary input power. The AIM module 118 is also configured to detect a presence of the input voltage, such as after the primary input power is switched back to the video-recording doorbell 102 in response to the activation time of the chime 106 ending. Further, the AIM module 118 can calculate an optimal charge current to charge the supercapacitor(s) 114 based on the power quality of the primary input power. In addition, the AIM module 118 can adjust the charge current as needed, such as when the input voltage dips, to prevent exceeding the capacity of the source of the primary input power. In some implementations, the AIM module 118 can measure the primary input power to determine compatibility of the primary input power (e.g., generated by the transformer 104 and provided via wiring) and/or a longest feasible activation time for the chime 106.

The ACM module 120 is configured to automatically adjust a maximum activation time for the chime 106. The ACM module 120 retrieves information generated by the AIM module 118 to calculate the maximum activation time for the chime 106. Based on the information indicating capabilities of the supercapacitor(s) 114 (e.g., discharge capabilities, recharge time), the ACM module 120 can automatically adjust or limit the duration of time that the chime 106 can generate the audio signal, such as by causing the controller of the chime connector 108 to adjust the setting of the lockout timer.

The electronic device 302 may also include a network interface 312. The electronic device 302 can use the network interface 312 for communicating data over wired, wireless, optical, or audio (e.g., acoustic) networks. By way of example and not limitation, the network interface 312 may communicate data over a local-area network (LAN), a wireless local-area network (WLAN), a home area network (HAN), a personal-area network (PAN), a wide-area network (WAN), an intranet, the Internet, a peer-to-peer network, a point-to-point network, or a mesh network. The network interface 312 can be implemented as one or more of a serial and/or parallel interface, a wireless interface, any type of network interface, a modem, or any other type of communication interface. Using the network interface 312, the electronic device 302 may communicate via a cloud computing service (e.g., the cloud service 212) to access a platform having resources.

The electronic device 302 also includes a camera system 314 (e.g., the camera 112). The camera system 314 is configured to capture images, video, and/or audio. Any suitable camera system 314 may be implemented in or communicatively coupled to the electronic device 302. The camera system 314 may be a digital camera that converts light captured by a lens to digital data representing a scene within the field of view of the lens. The camera system 314 can also include audio functionality configured to provide and receive audio communication. The audio functionality may be provided by integrated audio sensors for receiving audio input (e.g., via a microphone) and/or providing audio output (e.g., via a speaker). In an example, if the camera is disabled or inactive, the audio functionalities of the electronic device 302 can listen for and detect a voice input (e.g., the user reading aloud) of a serial number or bar code numbers. Such voice input can also be voice authenticated via an application on the electronic device 302 to verify that the voice belongs to the owner of the electronic device 302.

The electronic device 302 can also include a display 316 (e.g., touch display device 132). The display 316 can include any suitable touch-sensitive display device (e.g., a touchscreen, a liquid crystal display (LCD), a thin film transistor (TFT) LCD, an in-place switching (IPS) LCD, a capacitive touchscreen display, an organic light-emitting diode (OLED) display, an active-matrix organic light-emitting diode (AMOLED) display, a super AMOLED display, and so forth). The display 316 may be referred to as a display or a screen, such that digital content may be displayed on-screen.

The electronic device 302 also includes an enclosure 318 (e.g., housing). The enclosure 318 houses the various components of the electronic device 302, including, for example, the supercapacitor(s) 114 and the camera system 314. In aspects, the enclosure 318 includes at least two portions that are coupled together. The at least two portions of the enclosure 318 can be tightly fitted together with seals to prevent dust and water ingress into the circuitry and other components housed within the enclosure 318.

These and other capabilities and configurations, as well as ways in which entities of FIGS. 1 and 2 act and interact, are set forth in greater detail below. These entities may be further divided, combined, and so on. The system environment 100 of FIG. 1 and the detailed illustrations of FIG. 2 through FIG. 9 illustrate some of many possible environments, devices, and methods capable of employing the described techniques, whether individually or in combination with one another.

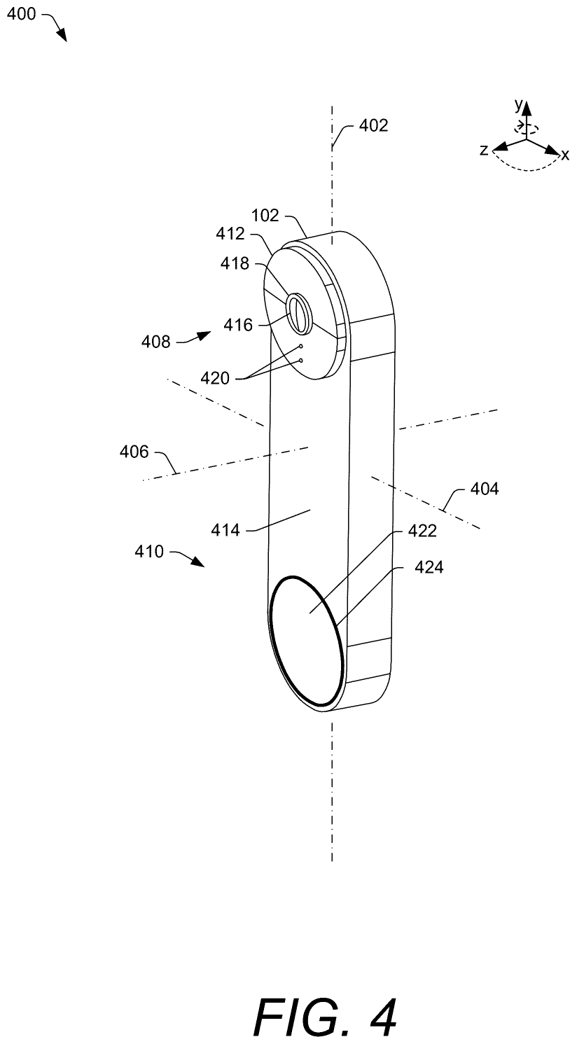

FIG. 4 illustrates an isometric view 400 of an example video-recording doorbell (e.g., the video-recording doorbell 102) having a camera module, in accordance with some implementations. The video-recording doorbell 102 is illustrated as having a longitudinal axis 402 (e.g., y-axis), a lateral axis 404 (e.g., x-axis), and a central axis 406 (e.g., z-axis). The doorbell 102 may be elongated along the longitudinal axis 402 such that the video-recording doorbell 102 has a height along the longitudinal axis 402 that is significantly greater (at least by a magnitude of two) than a width along the lateral axis 404, and the width is greater than a depth along the central axis 406. The video-recording doorbell 102 includes a camera-side end 408 and a button-side end 410. The camera-side end 408 of the video-recording doorbell 102 includes an infrared (IR) cover 412, which includes a portion that is substantially transparent (e.g., 70%, 80%, 90%, 100% transparent) or translucent to IR light and another portion that is substantially opaque (e.g., 70%, 80%, 90%, 100% opaque) to IR light.

In aspects, the IR cover 412 extends outwardly from a first surface 414 (e.g., front surface) of the housing (e.g., enclosure 318) of the video-recording doorbell 102. The IR cover 412 forms an annular shape with a center aperture through which a camera lens 416 of the camera module (e.g., camera system 314) extends. The annular shape is generally elliptical and in some cases, where its major and minor axes are equal, is circular. A retainer 418 (e.g., lens retainer) surrounds the camera lens 416 in the xy plane and extends through the center aperture of the IR cover 412 to protrude from an outer surface of the IR cover 412. In this way, the retainer 418 extends outwardly from the housing (and from the IR cover 412) and is exposed to the environment surrounding the doorbell 102. In an example, the retainer 418 has a substantially tubular shape (with an elliptical cross-section or a circular cross-section) and the camera lens 416 is positioned within a center area of the retainer 418. The retainer 418 reduces and/or prevents IR light from leaking into the camera lens 416 through the IR cover 412. The IR light may be provided by IR illuminators (e.g., IR LEDs) disposed behind the IR cover 412 and configured to direct the IR light through one or more apertures 420 in the IR cover 412. Also, the IR light may be received from the ambient environment, through the IR cover 412, and captured by a sensor (e.g., the image sensor, a passive infrared (PIR) sensor). Accordingly, the retainer 418 prevents the IR light from leaking into the sides or edges of the camera lens 416 from the IR cover 412.

The button-side end 410 of the doorbell 102 includes a button 422, which is pressable by a user to initiate a notification (e.g., audio signal). In aspects, the button 422 may be surrounded by a light ring 424, which may be substantially flush with the first surface 414 of the video-recording doorbell 102. The button 422 and/or light ring 424 may have a shape and/or size that substantially matches an outline and/or size of the IR cover 412. In an example, the button 422 may have a diameter that is substantially equal to the outer diameter of the IR cover 412. In another example, the light ring 424 has an outer diameter that is substantially the same as the outer diameter of the IR cover 412.

### Example System Configurations

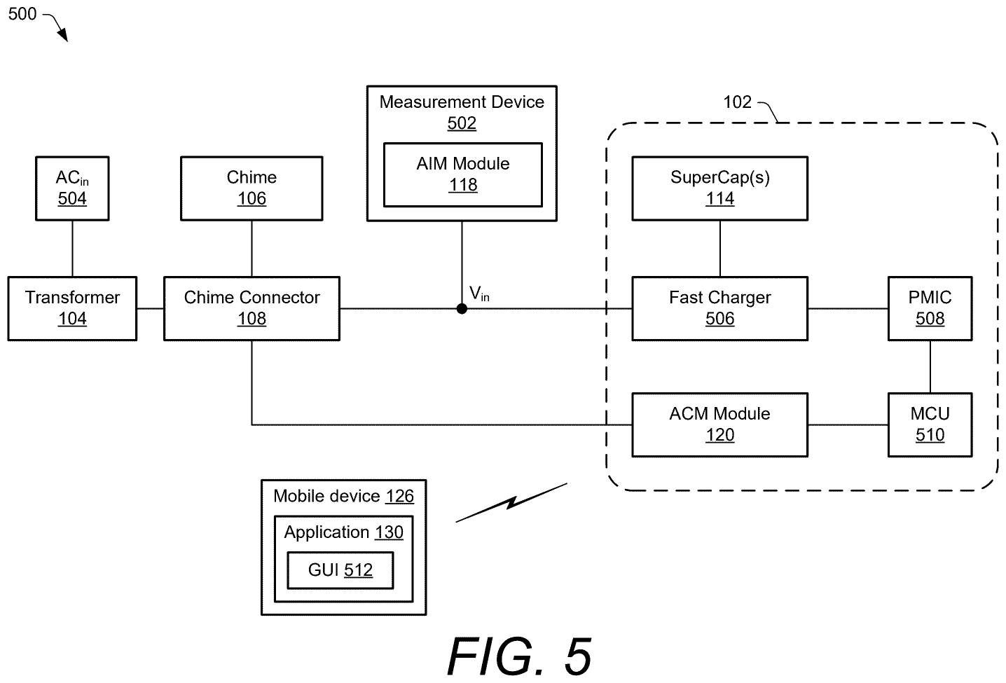

FIGS. 5-7 illustrates example implementations of video-recording doorbell systems 500, 600, and 700, respectively, in accordance with the techniques described herein. The example doorbell systems 500, 600, and 700 can be implemented in the system environment 100 of FIG. 1, the network environment 200 of FIG. 2, or any other environment suitable to enable the techniques and functionalities disclosed herein.

The example system 500 includes the video-recording doorbell 102 electrically connected to the transformer 104 and the chime 106 via a chime connector 108. The transformer 104 is wired to an alternating current (AC) source, ACᵢₙ 504, and is configured to down convert the AC (e.g., step down AC voltage from 110 V to a voltage in a range of 16 V˜24 V) as primary input power to the video-recording doorbell 102 or the chime 106, via the chime connector 108. In many implementations, the AC provided by the transformer 104 is sufficient to power one of the video-recording doorbell 102 or the chime 106 but not both simultaneously. Because of this, the video-recording doorbell 102 uses a secondary power source, such as the supercapacitor(s) 114, to provide secondary input power. When the chime 106 rings, the chime connector 108 acts to bypass the power from the transformer 104 to the chime 106. When the chime 106 finishes ringing, the chime connector 108 switches power back to the video-recording doorbell 102 and the fast charger 506 (e.g., the supercapacitor charger 116) charges the supercapacitor 114. Although supercapacitors have a significantly shorter discharge time compared to Li-ion batteries, the discharge time is generally sufficient for the video-recording doorbell system 500 in most scenarios. However, some scenarios may require modifications to prevent full depletion of the supercapacitors 114 and system shutdown. Such modifications are provided by the adaptive input manager module 118 (the AIM module 118) and, in some cases, the adaptive chime manager module 120 (the ACM module 120).

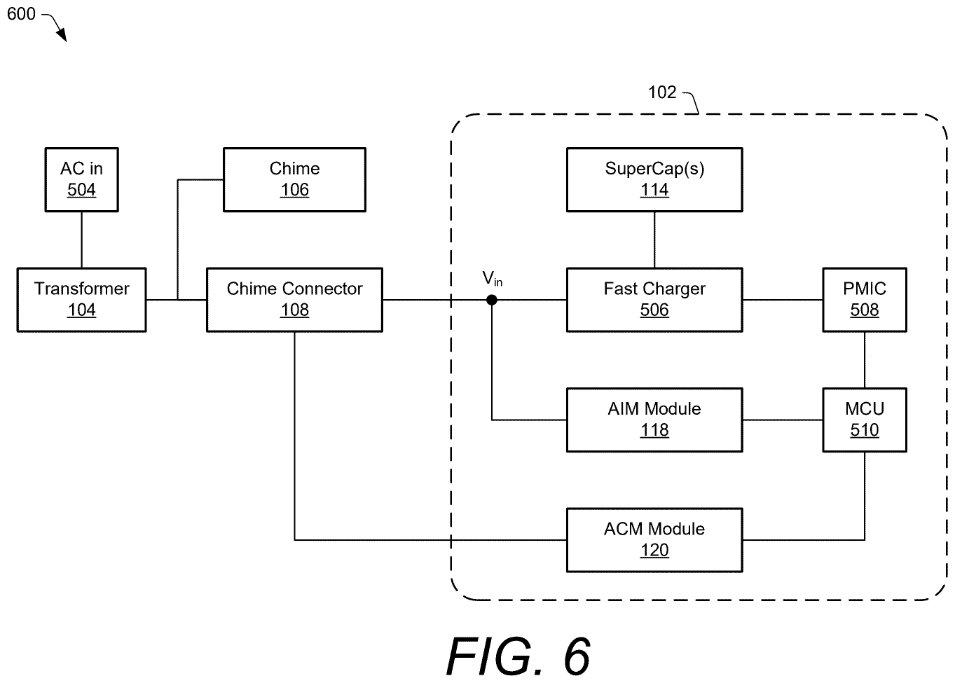

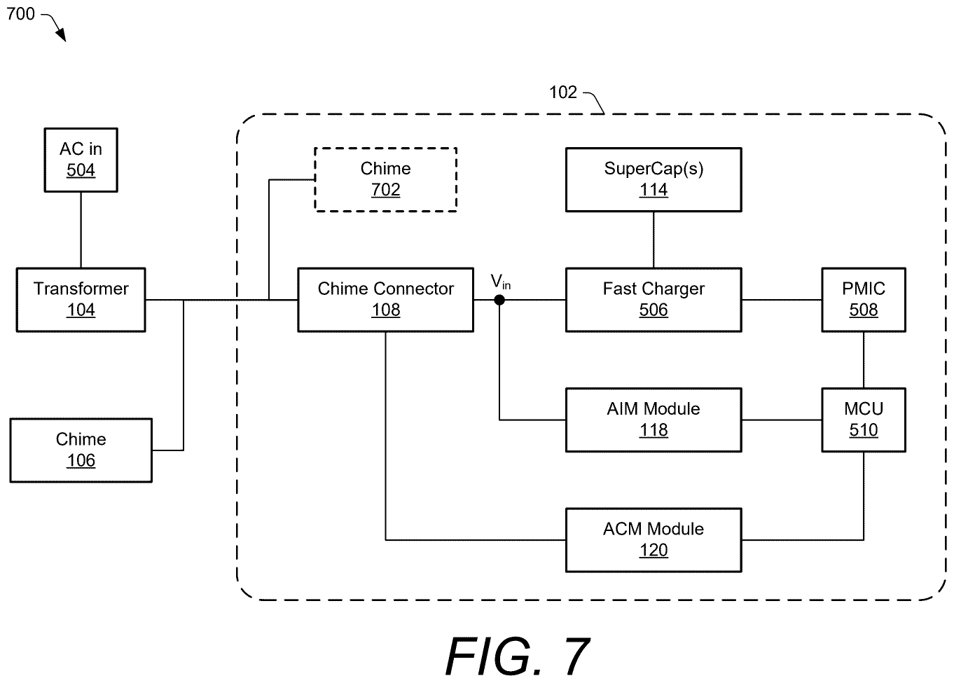

In the example doorbell system 500, the video-recording doorbell 102 includes, among other components, a fast charger 506, a power management integrated circuit (PMIC) 508, a microcontroller unit (MCU) 510, the supercapacitor(s) 114, and the ACM module 120. In the example doorbell system 600 in FIG. 6, the video-recording doorbell 102 also includes the AIM module 118. Compared with the doorbell system 600 in FIG. 6, the video-recording doorbell 102 in the example doorbell system 700 of FIG. 7 further includes the chime connector 108 and, in some cases, a chime 702.

The AIM module 118 is configured to measure a power quality of the primary input power, such as the power provided by the transformer 104. The term “power quality” represents a measure of electric power that drives a load and the load's ability to function properly. In aspects, the power quality represents a quality of the input voltage provided to the video-recording doorbell 102 by, for example, the transformer 104. In an example, the AIM module 118 measures the power quality of the primary input power generated by the transformer 104 and output by the chime connector 108. The power quality may be affected by the transformer 104 itself, such as a low-voltage transformer or a low-power transformer. Because the video-recording doorbell 102 can be installed in households with existing transformers, the household transformer may be a low-voltage transformer that may not be optimal for the video-recording doorbell system. Some household transformers may not be compatible with the video-recording doorbell 102 and the power quality measurement can be a helpful tool to determine whether to install the video-recording doorbell 102 or not in that household. In some cases, the wire between the transformer 104 and the video-recording doorbell 102 may be a small gauge wire or a long wire, reducing the power quality due to limited capacity or increased resistance in the wire.

After measuring the power quality of the primary input power, the AIM module 118 provides an output for the MCU 510 to determine the power capability for charging the supercapacitor 114. The MCU 510 stores the data received from the AIM module 118. Using the power quality of the primary input power, the MCU 510 can determine how fast to charge the supercapacitor(s) 114. In an example, the MCU 510 can determine a charge current for the fast charger 506 to use to charge the supercapacitor(s) 114 while maintaining sufficient power to operate the video-recording doorbell 102 and its components, including the MCU 510, the PMIC 508, the camera 112, etc. The MCU 510 sends a command to the fast charger 506 to control the charge current provided to the supercapacitor(s) 114 for charging. In some cases, the power quality is low, such that the charge current is low and therefore the supercapacitor(s) 114 are charged more slowly. In other cases, the power quality is high and the supercapacitor(s) 114 can be charged faster. One benefit of supercapacitors is that even with a low charge current the supercapacitors can be fully charged in a matter of seconds. The AIM module 118 enables the video-recording doorbell 102 to be adaptable to many existing household doorbell systems by adapting to the power quality of the primary input power and adjusting the charge current for charging the supercapacitors 114.

The ACM module 120 is configured to adjust a maximum time duration for an audio signal (e.g., ring) generated by the chime 106. Consider an example in which the chime 106 connected to the video-recording doorbell 102 is activated frequently in a relatively short period of time, such as on Halloween night when dozens or sometimes hundreds of children approach the household and ring the doorbell in the tradition of “trick-or-treating” for candy. Depending on the frequency of the doorbell's button being pressed to activate the chime 106, the video-recording doorbell 102 may not have sufficient time to fully charge the supercapacitors 114 before the chime 106 is activated again. If, for example, the supercapacitors 114 can provide secondary input power for about 10 seconds at a full charge, then the chime 106 can ring for about 10 seconds. However, if the supercapacitors 114 are not fully charged before a second activation of the chime 106 (e.g., a second trick-or-treating child presses the doorbell within a minute of a first child, a visitor presses the doorbell button repeatedly), then, without adaptive management, the doorbell may experience a system shutdown due to the limited capacity of the supercapacitors 114 to sustain multiple 10-second rings of the chime 106 without recharge time between rings. To prevent such a shutdown, the ACM module 120 can automatically adjust (e.g., decrease) the duration of time for activation of the chime 106, such as by limiting the maximum time duration that the chime 106 is permitted to generate an audio signal. Continuing with the above example, the ACM module 120 can reduce the duration of time for the chime 106 activation (also referred to as “activation time”) from 10 seconds to 8 seconds based on the current charge level of the supercapacitors 114 at the time of the chime 106 activation. If the chime 106 is activated again, the ACM module 120 can further reduce the activation time of the chime 106 to 6 seconds. These adjustments can be determined (e.g., calculated) by the MCU 510 based on information from the AIM module 118 regarding the power quality of the primary input power and based on the charge level and capabilities of the supercapacitors 114 to provide sufficient power to the video-recording doorbell 102 during the activation of the chime 106. The MCU 510 sends a command to the ACM module 120, and the ACM module 120 adjusts the activation time of the chime 106 accordingly.

The ACM module 120 can also automatically set the maximum activation time for the chime 106 at the time of installation based on capacity limits of the supercapacitors 114. For example, if the supercapacitors 114 can support secondary input power to the video-recording doorbell 102 for a maximum of 7 seconds, then the ACM module 120 can adjust the maximum chime activation to less than 7 seconds, even if the chime 106 is capable of ringing for a greater duration of time.

As shown in FIG. 5, the AIM module 118 can be separate from the video-recording doorbell 102. In such an example, a separate tool (e.g., measurement device 502) having the AIM module 118 can be used, prior to installing the video-recording doorbell 102, to measure the primary input power generated by the transformer 104 and determine, based on the output of the AIM module 118 (e.g., AIM results) if the system is compatible with the video-recording doorbell 102. If the system cannot support the video-recording doorbell 102 due to the power quality being below a threshold, then the technician can avoid the time, energy, and cost required to install the video-recording doorbell 102 in a non-compatible system. Further, the technician may avoid opening the packaging and breaking the packaging seal of a new video-recording doorbell product, thereby reducing product waste and cost. In one example, if the system is determined to be compatible with the video-recording doorbell 102, the user or technician can provide a user input having the AIM results (e.g., input voltage and input power capability) to an application (e.g., application 130 in FIG. 1) having a graphical user interface (GUI) 512 on the mobile device 126. The mobile device 126 can then wirelessly communicate the AIM results to the video-recording doorbell 102 to enable the video-recording doorbell 102 to adjust the charge current accordingly and the ACM module 120 can operate accordingly.

As shown in FIG. 6, the ACM module 120 can be disposed within the video-recording doorbell 102. Such an implementation enables the video-recording doorbell 102 to adjust the activation time of the chime 106 dynamically and as needed by the system 600.

As shown in FIG. 7, the chime connector 108 can also be disposed within the video-recording doorbell 102. Further, while the chime 106 is a mechanical chime or an electronic chime separate from the video-recording doorbell 102, installed generally inside the user's house to produce an audio signal within the house, the video-recording doorbell 102 can include an additional chime (e.g., chime 702). The chime 702 may be a mechanical chime or an electronic chime disposed within the housing of the video-recording doorbell 102. In such an implementation, the chime 702 can generate an audio signal that provides audio feedback to a visitor pressing the button to notify the visitor that their button press successfully rang the doorbell. Such feedback can be helpful to the visitor when they cannot hear the audio signal produced inside the house by the chime 106.

### Example User Interface

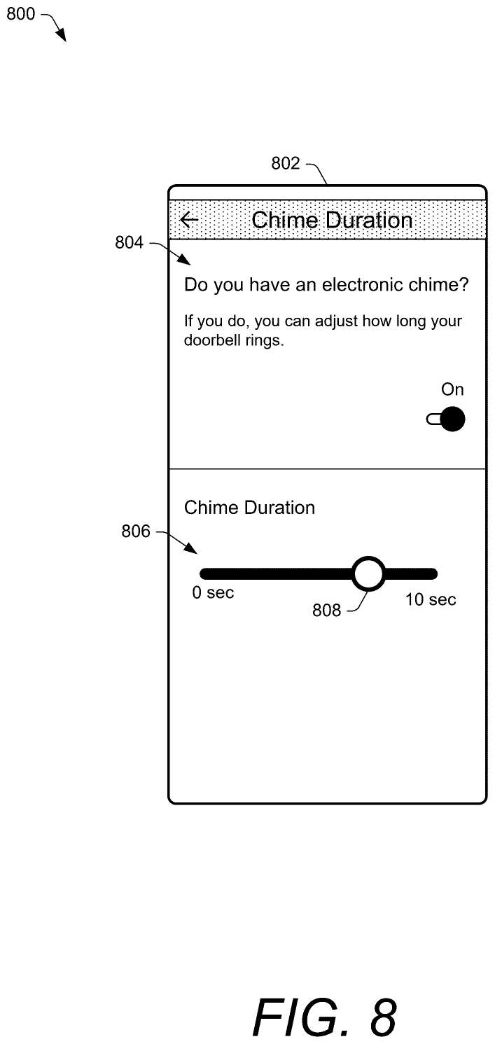

FIG. 8 illustrates an example implementation 800 of a user interface 802 for a mobile device configured to communicate with a video-recording doorbell system over a network. For example, the user interface 802 (e.g., the user interface 134) can be implemented by the mobile device 126, which can communicate wirelessly with the video-recording doorbell 102 over the network 124. The user interface 802 can be presented via the touch display device 132 of the mobile device 126. The user interface 802 can provide access to user-selectable settings associated with the video-recording doorbell system, particularly settings associated with power management.

For example, the user interface 802 can provide a user-selectable setting that sets the activation time for the chime 106. The video-recording doorbell 102 can wirelessly communicate information to the mobile device that is similar to the information sent to the ACM module 120. If the doorbell system includes an electronic chime (setting 804), the user may change the activation time for the chime 106 using the user interface 802 provided via the mobile device 126. The information can include a maximum activation time for the chime 106, which is calculated based on the primary input power provided to the video-recording doorbell 102 as well as the charge level and charge capabilities of the supercapacitors 114. Using such information, the mobile device 126 can limit the user-selectable setting for the activation time of the chime 106 to the maximum activation time determined by the video-recording doorbell 102. In one example, the user interface 802 displays a slider 806 on a scale from 0 to 10 seconds for the chime duration. If, however, the information from the video-recording doorbell 102 indicates that the maximum activation time for the chime 106 is 6 seconds, then the slider 806 may be presented on a scale from 0 to 6 seconds. Accordingly, the user-selectable settings (e.g., the slider 806) provided via the user interface 802 of the mobile device 126 can be adapted based on the information received from the video-recording doorbell 102 regarding the doorbell system power capabilities (including the power quality of the primary input power, the supercapacitor capabilities, etc.). Such adaptability can reduce user confusion and frustration when the user does not understand why they cannot increase the activation time of the chime 106 above, for example, a certain point in the middle of the slider 806. Instead, the range presented via the user interface 802 for the chime duration can include only usable values. In other examples, the range of the slider 806 may include values greater than the maximum activation time calculated by the video-recording doorbell 102. In such a case, a slider control 808 on the slider 806 may have movement limited to only a usable range of values, such as a range that is between 0 seconds and the maximum activation time. In some cases, the range is smaller than the usable range of 0 seconds to the maximum activation time.

### Example Methods

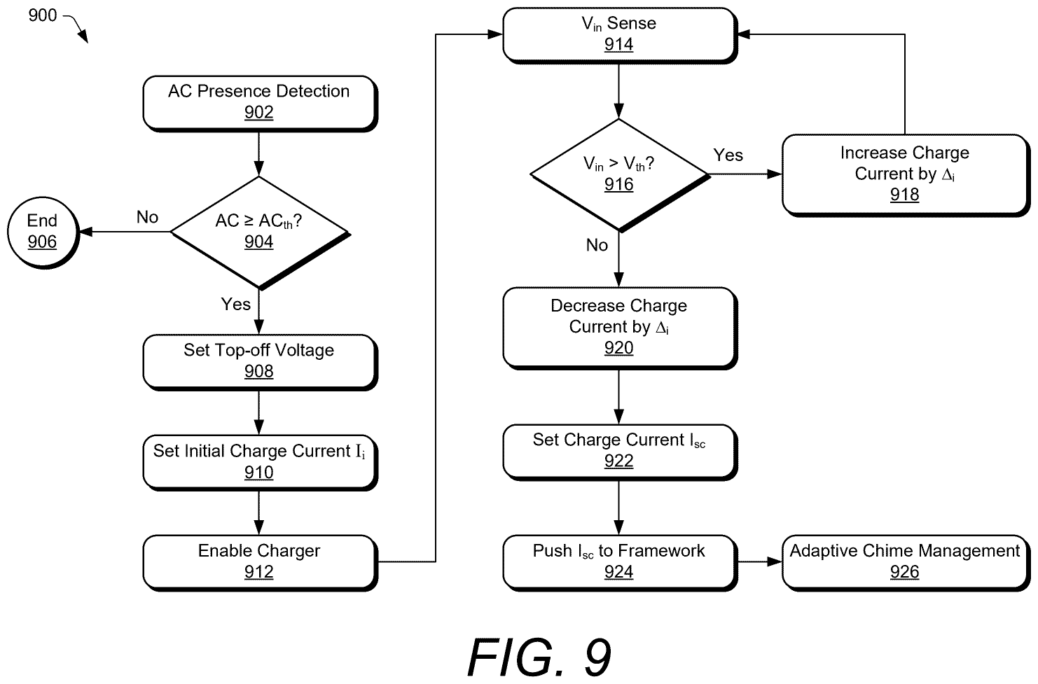

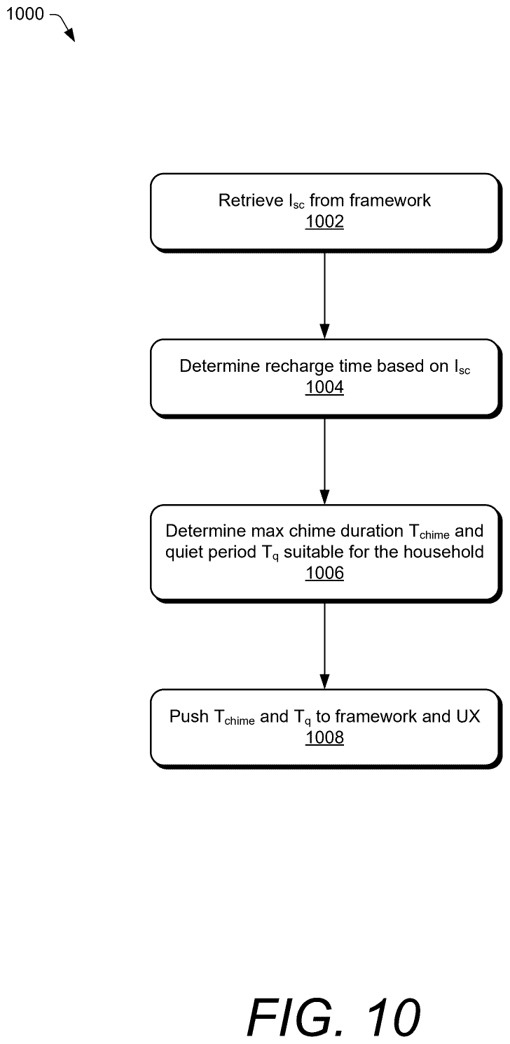

FIGS. 9 and 10 depict example methods 900 and 1000 for adaptive power management for video-recording doorbell systems as described herein. The methods 900 and 1000 can be performed by the video-recording doorbell 102, which uses the supercapacitor(s) 114, the AIM module 118, the MCU 510, the PMIC 508, the fast charger 506, and the ACM module 120 to implement the described techniques. Alternatively, the methods 900 and 1000 can be performed by any suitable electronic device that uses the supercapacitor(s) 114, the AIM module 118, the MCU 510, the PMIC 508, the fast charger 506, and the ACM module 120 to implement the described techniques. The methods 900 and 1000 collectively provide enhanced power management for electronic devices and systems such as the video-recording doorbell system, reliability for the supercapacitors 114, and user experience for the consumer. The method 1000 can be supplemental to, and can be optionally performed in conjunction with, the method 900.

The methods 900 and 1000 are shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example system environment 100 of FIG. 1, the example network environment 200 of FIG. 2, or to entities or processes as detailed in FIGS. 3-8, reference to which is made for example only. The techniques are not limited to performance by one entity or multiple entities operating on one device.

FIG. 9 depicts an example method for adaptive power management for an electronic device, such as a video-recording doorbell system, in accordance with one or more implementations described herein. At 902, presence of alternating current (AC) is detected. For example, an electronic device (e.g., the video-recording doorbell 102) can detect if primary input power is being received from an AC source. The primary input power, in one example, is generated by the transformer 104 and passed through the chime connector 108 and connecting wire(s) to the video-recording doorbell 102.

At 904, a determination is made as to whether the AC is above a threshold ACₜₕ. If the AC is below the threshold ACₜₕ (“NO” at 904), then the method 900 ends at 906 because there is insufficient AC input to power the video-recording doorbell 102. For example, the AIM module 118 can monitor an input voltage Vᵢₙ of the primary input power. In one example, the AIM module 118 determines that the AC is below the threshold ACₜₕ and does nothing (e.g., end 906), enabling the system to maintain current operation using secondary input power provided by the supercapacitors 114. In another example, if the AC is below the threshold ACₜₕ, the system may be turned off.

If, however, the AC is above or equal to the threshold ACₜₕ (“YES” at 904), then, at 908, a top-off voltage is set. For example, the MCU 510 can set the top-off voltage for charging the supercapacitors 114 at least based on the value of the detected AC.

At 910, an initial charge current Iᵢ is set. For example, the MCU 510 can use the information from the AIM module 118 to set a value for the initial charge current Iᵢ and send a corresponding command to the fast charger 506. The fast charger 506 can then set the initial charge current Iᵢ to the value determined by the MCU 510.

At 912, a charger is enabled. For example, the PMIC 508 can enable the fast charger 506, based on the command received from the MCU 510, to charge the supercapacitors 114 using the top-off voltage and the initial charge current Iᵢ.

At 914, the Vᵢₙ is sensed. For example, the AIM module 118 monitors the input voltage Vᵢₙ associated with the primary input power and provides a measurement for the input voltage Vᵢₙ to the MCU 510.

At 916, a determination is made, by the MCU 510, as to whether the input voltage Vᵢₙ is greater than a voltage threshold Vₜₕ. If the input voltage Vᵢₙ is greater than the voltage threshold Vₜₕ (“YES” at 916), then, at 918, the initial charge current Iᵢ is increased by an incremental value Δᵢ and the method 900 returns to repeat the operation at 914. The video-recording doorbell 102 continues to incrementally increase the charge current. During this feedback loop, the input voltage Vᵢₙ is continually monitored.

When the input voltage Vᵢₙ drops below, or is equal to, the voltage threshold Vₜₕ (“NO” at 916), the input power is insufficient for both operation of the video-recording doorbell 102 and charging the supercapacitors 114. Accordingly, at 920, the charge current is decreased by the increment value Δᵢ, which enables the input voltage Vᵢₙ to return to a value that is above the voltage threshold Vₜₕ, without exceeding the capacity of the AC source. In an example, the incremental loop of operations 914, 916, and 918 increases the charge current by Δᵢ over a number of iterations C, and then, responsive to the input voltage Vᵢₙ dropping below the voltage threshold Vₜₕ, the charge current is decreased by Δᵢ for one iteration. This incremental loop of operations 914, 916, and 918 and subsequent step 920 results in the initial charge current Iᵢ being increased by (C-1)Δᵢ, where C is the number of iterations of the loop of operations 914, 916, and 918.

At 922, a charge current I_{sc} is set. For example, the charge current I_{sc} can be set at a value determined based on the incremental loop described above, resulting in I_{sc}=Iᵢ+(C-1)Δᵢ. The MCU 510 sets the charge current I_{sc} at the determined value (e.g., a new charge current). The charge current I_{sc} is determined based on the power capability of the primary input power (e.g., the transformer 104 and/or the connecting wire between the transformer 104 and the video-recording doorbell 102).

At 924, the value of the charge current I_{sc} is pushed to a framework. For example, the charge current I_{sc} is stored at the MCU 510 (or an SoC) of the system.

At 926, adaptive chime management is performed, which includes at least some of the operations shown in FIG. 10. FIG. 10 depicts an example method for adaptive chime management, in accordance with one or more implementations described herein.

In FIG. 10, at 1002, the charge current I_{sc} is retrieved from the framework. For example, the ACM module 120 obtains information regarding the charge current I_{sc} from the MCU 510. The ACM module 120 can use the information regarding the charge current I_{sc} to determine whether to adjust a duration of time for the video-recording doorbell 102 to perform an action that uses power (e.g., record video during a chime activation time of the chime 106).

At 1004, a recharge time is determined based on the I_{sc}. For example, the ACM module 120 predicts an amount of time required to fully charge the supercapacitors 114 using the charge current I_{sc}.

At 1006, a maximum chime duration T_{chime} (or duration of time to perform an action that uses power) and a quiet period T_{q} suitable for the household are determined. For example, the ACM module 120 determines the maximum chime duration T_{chime} based on the capabilities of the supercapacitors 114, including the discharge time of the supercapacitors 114. To prevent complete depletion of the supercapacitors 114 and a resultant system shutdown, the ACM module 120 may include a buffer time in the calculation of the maximum discharge time of the supercapacitors 114. In addition, the ACM module 120 can calculate the quiet period T_{q}, which may be an amount of time before the chime 106 can be activated again. For example, the quiet period T_{q} may define an amount of time between an end of a first activation of the chime 106 and a start of a next activation of the chime 106 to enable the one or more supercapacitors 114 to be at least partially recharged. The quiet period T_{q} can be substantially equivalent to the amount of time required to fully recharge the supercapacitors 114. Alternatively, the quiet period T_{q} can be equivalent to a minimum amount of time to recharge the supercapacitors 114 to reach a capacity sufficient to operate the device for X seconds, enabling the chime 106 to ring for the X seconds. In one example, if the supercapacitors 114 can handle a 5-second chime activation, the quiet period T_{q} can be equal to an amount of time to recharge the supercapacitors 114 to a charge level that enables a 2-second chime activation. Depending on the charge current I_{sc}, the quiet period T_{q} may be 0.1 seconds, 0.25 seconds, 0.5 seconds, etc. During the quiet period T_{q}, the chime 106 cannot be activated even if a user is actively pressing the doorbell button.

At 1008, the maximum chime duration T_{chime} and the quiet period T_{q} are pushed to the framework and a user interface. For example, the maximum chime duration T_{chime} and the quiet period T_{q} are stored at the MCU 510 (or an SoC) of the device and the user interface 134. Through the user interface 134, the user of the doorbell can be provided with an option to adjust the chime duration between, for example, 0 seconds and the maximum chime duration T_{chime}. In one example, the system can also provide a setting through the user interface 134 that enables the user to adjust the quiet period T_{q}. The user setting may include a slider with a user-selectable control for adjusting the quiet period T_{q} between a minimum quiet period and a maximum quiet period. The maximum quiet period can be fixed, user-defined, or dynamically set by the system. In aspects, the ACM module 120 causes the activation time of the chime 106 to be set equal to or less than the maximum chime duration T_{chime}.

### Example Environments and Devices

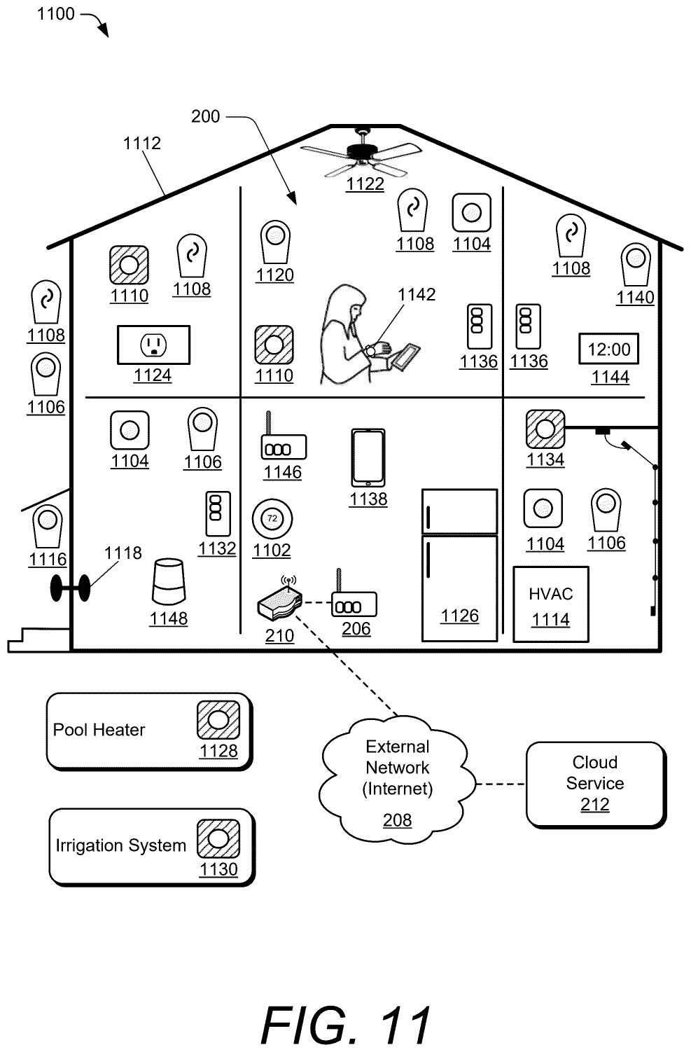

FIG. 11 illustrates an example environment 1100 in which a home area network (HAN), as described with reference to FIG. 1, and aspects of adaptive power management for video-recording doorbell systems can be implemented. Generally, the environment 1100 includes the HAN implemented as part of a home or other type of structure with any number of wireless network devices (e.g., wireless network devices 202, video-recording doorbell 102, mobile device 126, electronic device 302) that are configured for communication in a wireless network. For example, the wireless network devices can include a thermostat 1102, hazard detectors 1104 (e.g., for smoke and/or carbon monoxide), cameras 1106 (e.g., indoor and outdoor), lighting units 1108 (e.g., indoor and outdoor), and any other types of wireless network devices 1110 that are implemented inside and/or outside of a structure 1112 (e.g., in a home environment). In this example, the wireless network devices can also include any of the previously described devices, such as the border router 206, as well as the electronic device 302.

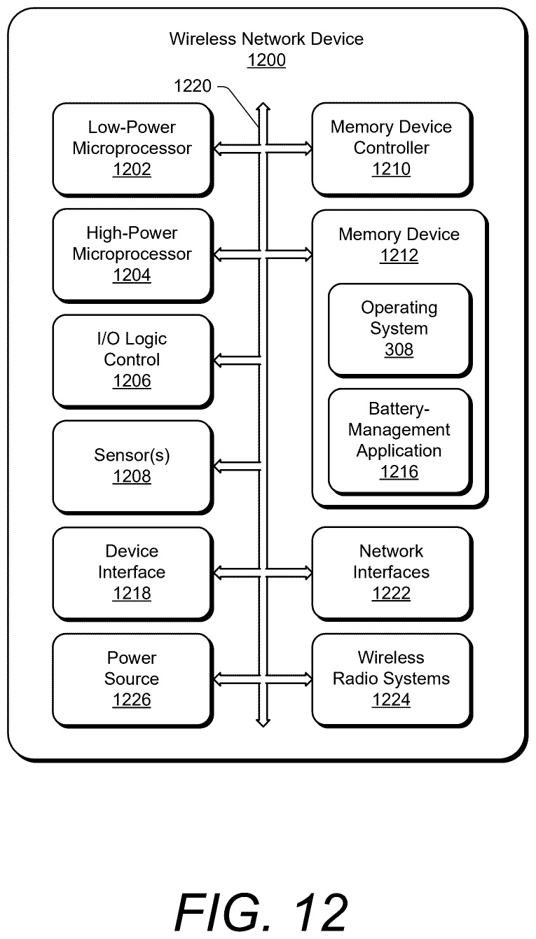

In the environment 1100, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 12.

In implementations, the thermostat 1102 may include a Nest® Learning Thermostat that detects ambient climate characteristics (e.g., temperature and/or humidity) and controls an HVAC system 1114 in the home environment. The learning thermostat 1102 and other network-connected devices “learn” by capturing occupant settings to the devices. For example, the thermostat 1102 learns preferred temperature set-points for mornings and evenings and when occupants of the structure 1112 are asleep or awake, as well as when the occupants are typically away or at home. In another example, the thermostat 1102 implements a radar system to detect a user approaching the thermostat 1102 to view a display of the thermostat 1102 and/or interact with the thermostat 1102. Such radar detection can be switched from a lower power radar to a higher power radar when the user is within a predefined distance from the thermostat 1102 to enable enhanced motion detection by the radar system, such as gesture recognition. Further, as the user moves closer to the thermostat 1102, the display of the thermostat 1102 can be modified (e.g., increased brightness, increased luminance) to enhance the visibility of content displayed via the display of the thermostat 1102 for the user.

A hazard detector 1104 can be implemented to detect a presence of a hazardous substance or a substance indicative of a hazardous substance (e.g., smoke, fire, or carbon monoxide). In examples of wireless interconnection, a hazard detector 1104 may detect the presence of smoke, indicating a fire in the structure 1112, in which case the hazard detector 1104 that first detects the smoke can broadcast a low-power wake-up signal to all of the connected wireless network devices. The other hazard detectors 1104 can then receive the broadcast wake-up signal and initiate a high-power state for hazard detection and to receive wireless communications of alert messages. Further, the lighting units 1108 can receive the broadcast wake-up signal and activate in a region of the detected hazard to illuminate and identify the problem area. In another example, the lighting units 1108 may activate in one illumination color to indicate a problem area or region in the structure 1112, such as for a detected fire or break-in, and activate in a different illumination color to indicate safe regions and/or escape routes out of the structure 1112.

In various configurations, the wireless network devices 1110 can include an entryway interface device 1116 (e.g., video-recording doorbell 102) that functions in coordination with a network-connected door lock system 1118 and that detects and responds to a person's approach to or departure from a location, such as an outer door of the structure 1112. The entryway interface device 1116 can interact with the other wireless network devices based on whether someone has approached or entered the smart-home environment. An entryway interface device 1116 can control doorbell functionality, announce the approach or departure of a person via audio or visual means, and control settings on a security system, such as to activate or deactivate the security system when occupants come and go. In another example, the entryway interface device 1116 implements a radar system to detect a user approaching the entryway interface device 1116 to view a display of the entryway interface device 1116 and/or interact with the entryway interface device 1116. Such radar detection can be switched from a lower power radar to a higher power radar when the user is within a predefined distance from the entryway interface device 1116 to enable enhanced motion detection by the radar system (e.g., gesture recognition), activate a camera of the entryway interface device 1116 (e.g., record video, capture still images, perform facial recognition), activate a display of the entryway interface device 1116, send a notification to another device of the user, etc. The supercapacitors 114 can be used to provide power to the radar system to execute the higher power radar while one or more other systems are initializing (e.g., powering up), such as the camera. In some instances, the supercapacitors 114 can provide power to operate the camera, such as by capturing images or recording video.

The wireless network devices 1110 can also include other sensors and detectors, such as to detect ambient lighting conditions, detect room-occupancy states (e.g., with an occupancy sensor 1120), and control a power and/or dim state of one or more lights. In some instances, the sensors and/or detectors may also control a power state or speed of a fan, such as a ceiling fan 1122. Further, the sensors and/or detectors may detect occupancy in a room or enclosure and control the supply of power to electrical outlets or devices 1124, such as if a room or the structure 1112 is unoccupied.

The wireless network devices 1110 may also include connected appliances and/or controlled systems 1126, such as refrigerators, stoves and ovens, washers, dryers, or air conditioners, pool heaters 1128, irrigation systems 1130, security systems 1132, and so forth, as well as other electronic and computing devices, such as televisions, entertainment systems, computers, intercom systems, garage-door openers 1134, ceiling fans 1122, control panels 1136, and the like. When plugged in, an appliance, device, or system can announce itself to the HAN as described above and can be automatically integrated with the controls and devices of the HAN, such as in the home. It should be noted that the wireless network devices 1110 may include devices physically located outside of the structure 1112 but within wireless communication range, such as a device controlling a swimming pool heater 1128 or an irrigation system 1130.

As described above, the HAN includes a border router 206 that interfaces for communication with an external network 208, outside the HAN. The border router 206 connects to an access point 210, which connects to the external network 208, such as the Internet. A cloud service 212, which is connected via the external network 208, provides services related to and/or using the devices within the HAN. By way of example, the cloud service 212 can include applications for connecting end-user devices 1138, such as smartphones, tablets, and the like, to devices in the HAN, processing and presenting data acquired in the HAN to end-users, linking devices in one or more HANs to user accounts of the cloud service 212, provisioning and updating devices in the HAN, and so forth. For example, a user can control the thermostat 1102 and other wireless network devices in the environment 1100 using a network-connected computer or portable device, such as a mobile phone or tablet device. Further, the wireless network devices can communicate information to any central server or cloud-computing system via the border router 206 and the access point 210. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, and so on).

Any of the wireless network devices in the HAN can serve as low-power and communication nodes to create the HAN in the home environment. Individual low-power nodes of the network can regularly send out messages regarding what they are sensing, and the other low-powered nodes in the environment—in addition to sending out their own messages—can the messages, thereby communicating the messages from node to node (e.g., from device to device) throughout the HAN. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, the occupancy sensor 1120 and/or an ambient light sensor 1140 can detect an occupant in a room as well as measure the ambient light and activate a light source when the ambient light sensor 1140 detects that the room is dark and when the occupancy sensor 1120 detects that someone is in the room. Further, the occupancy sensor 1120 and/or an ambient light sensor 1140 can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor 1120 detecting the presence of a person in the room. As mentioned above, these messages may be sent wirelessly, using the HAN, from node to node (e.g., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, an alarm could still be triggered by receiving an occupancy, motion, heat, sound, etc. message from one or more of the low-powered mesh nodes in the HAN. In other implementations, the HAN can be used to automatically turn on and off the lighting units 1108 as a person transitions from room to room in the structure 1112. For example, the wireless network devices can detect the person's movement through the structure 1112 and communicate corresponding messages via the nodes of the HAN. Using the messages that indicate which rooms are occupied, other wireless network devices that receive the messages can activate and/or deactivate accordingly. As referred to above, the HAN can also be utilized to provide exit lighting in the event of an emergency, such as by turning on the appropriate lighting units 1108 that lead to a safe exit. The lighting units 1108 may also be turned on to indicate the direction along an exit route that a person should travel to safely exit the structure 1112.

The various wireless network devices may also be implemented to integrate and communicate with wearable computing devices 1142, such as may be used to identify and locate an occupant of the structure 1112 and adjust the temperature, lighting, sound system, and the like accordingly. In other implementations, radio frequency identification (RFID) sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared or near-field communication (NFC) techniques (e.g., a person wearing an infrared or NFC-capable smartphone) may be used, along with rules-based inference engines or artificial intelligence techniques that draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the HAN, conforming to the wireless interconnection protocols for communicating on the HAN.

The wireless network devices 1110 may also include a network-connected alarm clock 1144 for each of the individual occupants of the structure 1112 in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the HAN based on a unique signature of the person, which is determined based on data obtained from sensors located in the wireless network devices, such as sensors that include ultrasonic sensors, passive IR sensors, and the like. The unique signature of an occupant can be based on a combination of patterns of movement, voice, height, size, etc., as well as using facial or audio recognition techniques.

In an example of wireless interconnection, the wake time for an individual can be associated with the thermostat 1102 to control the HVAC system in an efficient manner so as to pre-heat or cool the structure 1112 to desired sleeping and awake temperature settings. The preferred settings can be learned over time, such as by capturing the temperatures set in the thermostat 1102 before the person goes to sleep and upon the person waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 1102 so as to pre-heat or cool the environment to a desired setting and turning on or turning off the lighting units 1108.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage. ” Similarly, the wireless network devices can be utilized to detect a subtle sound, vibration, and/or motion of unwanted pests, such as mice and other rodents, as well as termites, cockroaches, and other insects. The system can then notify an occupant of the suspected pests in the environment, such as with warning messages to help facilitate early detection and prevention.

The environment 1100 may include one or more wireless network devices that function as a hub 1146. The hub 1146 (e.g., hub 220) may be a general-purpose home automation hub, or an application-specific hub, such as a security hub, an energy management hub, an HVAC hub, and so forth. The functionality of the hub 1146 may also be integrated into any wireless network device, such as a network-connected thermostat device or the border router 206. Hosting functionality on the hub 1146 in the structure 1112 can improve reliability when the user's internet connection is unreliable, can reduce latency of operations that would normally have to connect to the cloud service 212, and can satisfy system and regulatory constraints around local access between wireless network devices.

Additionally, the example environment 1100 includes a network-connected speaker 1148. The network-connected speaker 1148 provides voice assistant services that include providing voice control of network-connected devices. The functions of the hub 1146 may be hosted in the network-connected speaker 1148. The network-connected speaker 1148 can be configured to communicate via the HAN, which may include a wireless mesh network, a Wi-Fi network, or both.

FIG. 12 illustrates an example wireless network device 1200 that can be implemented as any of the wireless network devices 202 (e.g., video-recording doorbell 102, mobile device 126, electronic device 302) in a HAN in accordance with one or more aspects of adaptive power management for video-recording doorbell systems as described herein. The device 1200 can be integrated with electronic circuitry, microprocessors, memory, input/output (I/O) logic control, communication interfaces and components, and other hardware, firmware, and/or software to implement the device 1200 in a HAN. Further, the wireless network device 1200 can be implemented with various components, such as with any number and combination of different components as further described with reference to the example device shown in FIG. 9.

In this example, the wireless network device 1200 includes a low-power microprocessor 1202 and a high-power microprocessor 1204 (e.g., microcontrollers or digital signal processors) that process executable instructions. The device 1200 also includes an input-output (I/O) logic control 1206 (e.g., to include electronic circuitry). The microprocessors 1202 and 1204 can include components of an integrated circuit, a programmable logic device, a logic device formed using one or more semiconductors, and other implementations in silicon and/or hardware, such as a processor and memory system implemented as a system-on-chip (SoC). Alternatively or in addition, the device 1200 can be implemented with any one or combination of software, hardware, firmware, or fixed logic circuitry that may be implemented with processing and control circuits. The low-power microprocessor 1202 and the high-power microprocessor 1204 can also support one or more different device functionalities of the device 1200. For example, the high-power microprocessor 1204 may execute computationally intensive operations, whereas the low-power microprocessor 1202 may manage less complex processes such as detecting a hazard or temperature from one or more sensors 1208. The low-power microprocessor 1202 may also wake or initialize the high-power microprocessor 1204 for computationally intensive processes.

The one or more sensors 1208 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 1208 may include any one or a combination of temperature sensors, humidity sensors, hazard-related sensors, other environmental sensors, accelerometers, microphones, optical sensors up to and including cameras (e.g., charged coupled-device or video cameras), active or passive radiation sensors, GPS receivers, and RF identification detectors. In implementations, the wireless network device 1200 may include one or more primary sensors, as well as one or more secondary sensors, such as primary sensors that sense data central to the core operation of the device 1200 (e.g., sensing a temperature in a thermostat or sensing smoke in a smoke detector) and secondary sensors that sense other types of data (e.g., motion, light or sound), which can be used for energy-efficiency objectives or automation objectives.

The wireless network device 1200 includes a memory device controller 1210 and a memory device 1212, such as any type of a nonvolatile memory and/or other suitable electronic data storage device. The wireless network device 1200 can also include various firmware and/or software, such as an operating system 1214 that is maintained as computer-executable instructions by the memory and executed by a microprocessor. The device software may also include a battery-management application 1216 that implements aspects of adaptive power management for video-recording doorbell systems. In one example, the battery-management application 1216 may instead be a supercapacitor-management application that implements aspects of adaptive power management for video-recording doorbell systems. The wireless network device 1200 also includes a device interface 1218 to interface with another device or peripheral component and includes an integrated data bus 1220 that couples the various components of the wireless network device 1200 for data communication between the components. The data bus 1220 in the wireless network device 1200 may also be implemented as any one or a combination of different bus structures and/or bus architectures.

The device interface 1218 may receive input from a user and/or provide information to the user (e.g., as a user interface), and a received input can be used to determine a setting. The device interface 1218 may also include mechanical or virtual components that respond to a user input. For example, the user can mechanically move a sliding or rotatable component, or motion along a touchpad may be detected, and such motions may correspond to a setting adjustment of the device 1200. Physical and virtual movable user-interface components can allow the user to set a setting along a portion of an apparent continuum. The device interface 1218 may also receive inputs from any number of peripherals, such as buttons, a keypad, a switch, a microphone, and an imager (e.g., a camera device).

The wireless network device 1200 can include network interfaces 1222 (e.g., network interface 312), such as a HAN interface for communication with other wireless network devices in a HAN and an external network interface for network communication, such as via the Internet. The wireless network device 1200 also includes wireless radio systems 1224 for wireless communication with other wireless network devices via the HAN interface and for multiple, different wireless communications systems. The wireless radio systems 1224 may include Wi-Fi, Bluetooth™, Mobile Broadband, BLE, and/or point-to-point IEEE 802.15.4. Each of the different radio systems 1224 can include a radio device, antenna, and chipset that is implemented for a particular wireless communications technology. The wireless network device 1200 also includes a power source 1226, such as a supercapacitor (e.g., supercapacitor(s) 114) and/or a cable to connect the device 1200 to line voltage. An AC power source may also be used to charge the supercapacitor of the device 1200.

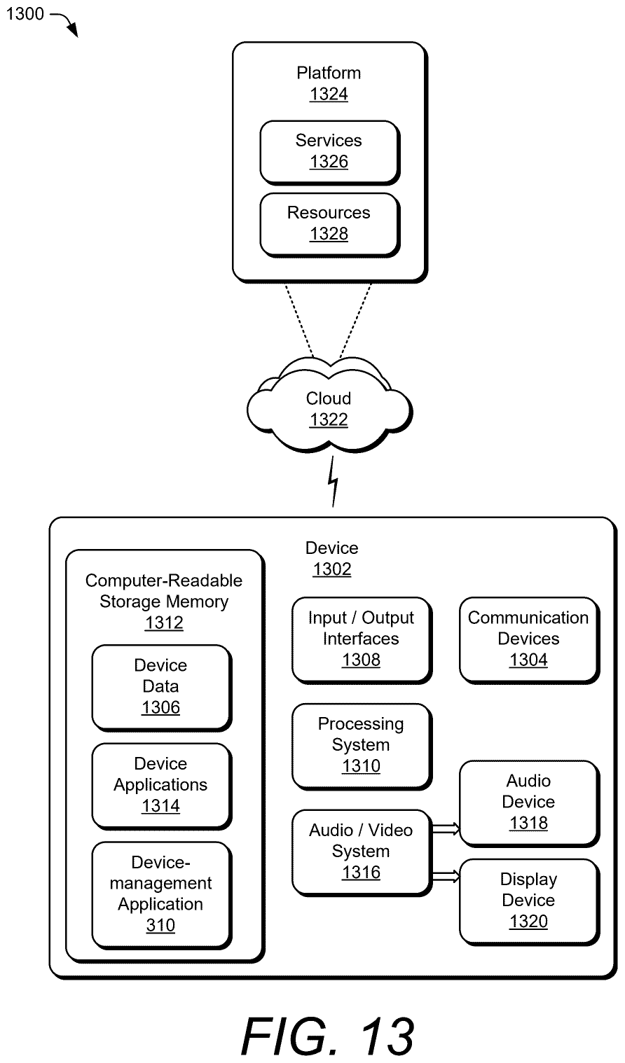

FIG. 13 illustrates an example system 1300 that includes an example device 1302, which can be implemented as any of the wireless network devices 202 (e.g., video-recording doorbell 102, mobile device 126, electronic device 302) that implement aspects of adaptive power management for video-recording doorbell systems as described with reference to the previous FIGS. 1-12. The example device 1302 may be any type of computing device, client device, mobile phone, tablet, communication device, entertainment device, gaming device, media playback device, and/or other type of device. Further, the example device 1302 may be implemented as any other type of wireless network device that is configured for communication on a HAN, such as a thermostat, a hazard detector, a camera, a light unit, a commissioning device, a router, a border router, a joiner router, a joining device, an end device, a leader, an access point, and/or other wireless network devices.

The device 1302 includes communication devices 1304 that enable wired and/or wireless communication of device data 1306, such as data that is communicated between devices in a HAN, data that is being received, data scheduled for broadcast, data packets of the data, data that is synchronized between the devices, etc. The device data 1306 can include any type of communication data, as well as audio, video, and/or image data that is generated by applications executing on the device 1302. The communication devices 1304 can also include transceivers for cellular phone communication and/or for network data communication.

The device 1302 also includes input/output (I/O) interfaces 1308, such as data network interfaces (e.g., network interface 312) that provide connection and/or communication links between the device 1302, data networks (e.g., a HAN, external network, etc.), and other devices. The I/O interfaces 1308 can be used to couple the device 1302 to any type of components, peripherals, and/or accessory devices. The I/O interfaces 1308 also include data input ports via which any type of data, media content, and/or inputs can be received, such as user inputs to the device 1302, as well as any type of communication data, as well as audio, video, and/or image data received from any content and/or data source.

The device 1302 includes a processing system 1310 (e.g., processors 110) that may be implemented at least partially in hardware, such as with any type of microprocessors, controllers, and the like that process executable instructions. The processing system 1310 can include components of an integrated circuit, a programmable logic device, a logic device formed using one or more semiconductors, and other implementations in silicon and/or hardware, such as a processor and memory system implemented as an SoC. Alternatively or in addition, the device can be implemented with any one or combination of software, hardware, firmware, or fixed logic circuitry that may be implemented with processing and control circuits. The device 1302 may further include any type of a system bus or other data and command transfer system that couples the various components within the device 1302. A system bus can include any one or combination of different bus structures and architectures, as well as control and data lines.

The device 1302 also includes computer-readable storage memory 1312 (e.g., CRM 304), such as data storage devices that can be accessed by a computing device and that provide persistent storage of data and executable instructions (e.g., software applications, modules, programs, functions, and the like). The computer-readable storage memory 1312 described herein excludes propagating signals. Examples of computer-readable storage memory include volatile memory and non-volatile memory, fixed and removable media devices, and any suitable memory device or electronic data storage that maintains data for computing device access. The computer-readable storage memory 1312 can include various implementations of random access memory (RAM), read-only memory (ROM), flash memory, erasable programmable read-only memory (EPROM), electrically erasable programmable read-only memory (EEPROM), and other types of storage memory in various memory device configurations.

The computer-readable storage memory 1312 provides storage of the device data 1306 and various device applications 1314 (e.g., applications 306), such as an operating system (e.g., operating system 308) that is maintained as a software application with the computer-readable storage memory 1312 and executed by the processing system 1310. The device applications 1314 may also include a device manager, such as any form of a control application, a software application, a signal processing and control module, code that is native to a particular device, a hardware abstraction layer for a particular device, and so on. In this example, the device applications 1314 also include a device-management application 310 that implements aspects of adaptive power management for video-recording doorbell systems, such as when the example device 1302 is implemented as the electronic device 302 and a target device is remote and implemented as any of the wireless network devices described herein. In aspects, the device-management application 310 implements the AIM module 118 and the ACM module 120 according to techniques described herein.

The device 1302 also includes an audio and/or video system 1316 that generates audio data for an audio device 1318 and/or generates display data for a display device 1320 (e.g., display 316). The audio device 1318 and/or the display device 1320 include any devices that process, display, and/or otherwise render audio, video, display, and/or image data, such as the image content of a digital photo. In implementations, the audio device 1318 and/or the display device 1320 are integrated components of the example device 1302. Alternatively, the audio device 1318 and/or the display device 1320 are external, peripheral components to the example device 1302. In aspects, at least part of the techniques described for adaptive power management for video-recording doorbell systems may be implemented in a distributed system, such as over a “cloud” 1322 in a platform 1324. The cloud 1322 includes and/or is representative of the platform 1324 for services 1326 and/or resources 1328.

The platform 1324 abstracts underlying functionality of hardware, such as server devices (e.g., included in the services 1326) and/or software resources (e.g., included as the resources 1328), and connects the example device 1302 with other devices, servers, etc. The resources 1328 may also include applications and/or data that can be utilized while computer processing is executed on servers that are remote from the example device 1302. Additionally, the services 1326 and/or the resources 1328 may facilitate subscriber network services, such as over the Internet, a cellular network, or a Wi-Fi network. The platform 1324 may also serve to abstract and scale resources to service a demand for the resources 1328 that are implemented via the platform 1324, such as in an interconnected device aspect with functionality distributed throughout the system 1300. For example, the functionality may be implemented in part at the example device 1302 as well as via the platform 1324 that abstracts the functionality of the cloud 1322.

### Conclusion

Although aspects of adaptive power management for video-recording doorbell systems have been described in language specific to features and/or methods, the subject of the appended claims is not necessarily limited to the specific features or methods described. Rather, the specific features and methods are disclosed as example implementations of the techniques for adaptive power management for video-recording doorbell systems, and other equivalent features and methods are intended to be within the scope of the appended claims. Further, various different aspects are described, and it is to be appreciated that each described aspect can be implemented independently or in connection with one or more other described aspects.

What is claimed is:

1. A video-recording doorbell comprising:
a housing;
one or more supercapacitors disposed within the housing, the one or more supercapacitors configured to provide secondary input power for operation of the video-recording doorbell when primary input power is temporarily switched to provide power to a doorbell chime electrically connected to the video-recording doorbell;
a charger configured to charge the one or more supercapacitors;
an adaptive input manager module configured to:
detect a presence of the primary input power; and
determine an input voltage of the primary input power; and
a microcontroller unit (MCU) configured to:
set an initial charge current for charging the one or more supercapacitors;
adjust the initial charge current to a new charge current based on the input voltage and a voltage threshold; and
send a command to the charger to charge the one or more supercapacitors at the new charge current.

2. The video-recording doorbell of claim 1, wherein the video-recording doorbell further comprises a power management integrated circuit (PMIC) configured to enable the charger to charge the one or more supercapacitors based on the new charge current.

3. The video-recording doorbell of claim 1, wherein the video-recording doorbell further comprises an adaptive chime manager module configured to:
receive, from the adaptive input manager module, information associated with a power quality of the primary input power, a charge level of the one or more supercapacitors, and discharge capabilities of the one or more supercapacitors; and
adjust, based on the information from the adaptive input manager module, a time duration for an audio signal to be generated by the doorbell chime.

4. The video-recording doorbell of claim 3, wherein the adaptive chime manager module is configured to adjust the time duration by reducing an amount of time that the doorbell chime is permitted to generate the audio signal.

5. The video-recording doorbell of claim 3, wherein the adaptive chime manager module is configured to:
determine that the power quality has dropped below a threshold value; and
in response to the determination that the power quality has dropped below the threshold value, automatically decrease the time duration for the audio signal to be generated by the doorbell chime.

6. The video-recording doorbell of claim 5, wherein the adaptive chime manager module is further configured to:
after the time duration has been automatically decreased, determine that the power quality has changed to exceed the threshold value; and
responsive to the input voltage exceeding the threshold value, automatically increase the time duration for the audio signal to be generated by the doorbell chime.

7. The video-recording doorbell of claim 1, wherein the video-recording doorbell further comprises a button integrated with the housing, wherein the button is pressable by a user to cause the doorbell chime to generate an audio signal.

8. The video-recording doorbell of claim 7, wherein the video-recording doorbell further comprises a chime connector configured to, responsive to the button being pressed, switch the primary input power to the doorbell chime to generate the audio signal.

9. The video-recording doorbell of claim 1, wherein the MCU is configured to:
adjust the initial charge current incrementally until the input voltage drops below a voltage threshold; and
responsive to the input voltage dropping below the voltage threshold, decrease the incrementally adjusted charge current to the new charge current to enable the input voltage to return to a value that is above the voltage threshold.

10. A video-recording doorbell system comprising:
a video-recording doorbell having one or more supercapacitors configured to provide secondary input power to the video-recording doorbell;
a doorbell chime electrically connected to the video-recording doorbell and configured to generate an audio signal in response to activation of a button on the video-recording doorbell;
a transformer connected to the doorbell chime and the video-recording doorbell, the transformer configured to provide primary input power to the video-recording doorbell;
a chime connector connected to the doorbell chime and the video-recording doorbell, the chime connector configured to switch the primary input power between the video-recording doorbell and the doorbell chime based on activation of the button;
an adaptive input manager module implemented in the video-recording doorbell and configured to:
determine a voltage of the primary input power; and
determine a power quality of the primary input power based on the voltage; and
a microcontroller disposed within the video-recording doorbell and configured to:
set an initial charge current for charging the one or more supercapacitors;
enable charging of the one or more supercapacitors using the initial charge current; and
adjust the initial charge current to a new charge current based on the power quality and a threshold value.

11. The video-recording doorbell system of claim 10, further comprising a supercapacitor charger for charging the one or more supercapacitors based on the new charge current.

12. The video-recording doorbell system of claim 10, wherein the video-recording doorbell is configured to provide information to a mobile device over a wireless network to present a user interface with a user-selectable control for adjusting an activation time for the doorbell chime.

13. The video-recording doorbell system of claim 12, wherein the information includes an activation time for the doorbell chime, the activation time determined based on a charge level and discharge capabilities of the one or more supercapacitors.

14. The video-recording doorbell system of claim 10, further comprising an adaptive chime manager module configured to:
receive, from the adaptive input manager module, information associated with a power quality of the primary input power, a charge level of the one or more supercapacitors, and discharge capabilities of the one or more supercapacitors; and
adjust, based on the information from the adaptive input manager module, a time duration for an audio signal to be generated by the doorbell chime.

15. The video-recording doorbell system of claim 14, wherein the adaptive chime manager module is configured to adjust the time duration by decreasing the time duration that the doorbell chime is permitted to generate the audio signal.

16. The video-recording doorbell system of claim 14, wherein the adaptive chime manager module is configured to:
determine that the voltage has dropped below a voltage threshold; and
responsive to the voltage dropping below the voltage threshold, automatically decrease the time duration for the audio signal to be generated by the doorbell chime.

17. The video-recording doorbell system of claim 16, wherein the adaptive chime manager module is configured to:
after the time duration has been automatically decreased, determine that the voltage has changed to exceed the voltage threshold; and
responsive to the voltage exceeding the threshold value, automatically increase the time duration of the audio signal to be generated by the doorbell chime.

18. A method comprising:
retrieving information regarding a charge current being used to charge one or more supercapacitors of an electronic device, the one or more supercapacitors configured to provide secondary power to the electronic device during activation of an action that uses power;
determining a recharge time, based on the information regarding the charge current, to fully charge the one or more supercapacitors of the electronic device;
determining a duration of time for the action based on a capability and discharge time of the one or more supercapacitors; and
causing an activation time of the action to be set equal to or less than the determined duration of time.

19. The method of claim 18, wherein the electronic device is a video-recording doorbell.

20. The method of claim 18, further comprising:
determining a quiet period for the electronic device, the quiet period defining an amount of time between an end of a first activation of the action and a start of a next activation of the action to enable the one or more supercapacitors to be at least partially recharged, wherein the quiet period is based on the recharge time.
